(19) United States
(12) Patent Application Publication
(10) Pub. No.: US 2026/0104600 A1
(43) Pub. Date: Apr. 16, 2026

(54) HINGE FOR A PAIR OF AUGMENTED-REALITY GLASSES THAT ALLOWS FOR A FLEXIBLE CIRCUIT TO PASS THROUGH

(71) Applicant: Meta Platforms Technologies, LLC, Menlo Park, CA (US)

(72) Inventors: Brian Aznoe, Sherwood, OR (US); Jonathon Spafford, Amboy, WA (US); Kaiyang Sun, Woodinville, WA (US)

(21) Appl. No.: 19/354,707

(22) Filed: Oct. 9, 2025

Related U.S. Application Data
(60) Provisional application No. 63/708,217, filed on Oct. 16, 2024.

(51) Int. Cl. G02C 11/00; G02B 27/01; G02C 5/22

(52) U.S. Cl. CPC G02C 11/10; G02B 27/0176; G02C 5/22

(57) ABSTRACT

An example extended-reality glasses described herein includes a hinge that is configured to allow a flexible printed circuit to pass through the hinge. The hinge is configured to have an upper portion and a lower portion and to allow the flexible printed circuit to pass through the hinge between the upper and lower portions. The flexible printed circuit is able to connect electronic components within a temple arm on one side of the hinge to electronic components within a frame section on another side of the hinge.

### RELATED APPLICATION

This application claims priority to U.S. Provisional Application Ser. No. 63/708,217, filed Oct. 16, 2024, entitled “HINGE FOR A PAIR OF AUGMENTED-REALITY GLASSES THAT ALLOWS FOR A FLEXIBLE CIRCUIT TO PASS THROUGH,” which is incorporated herein by reference.

### TECHNICAL FIELD

This relates generally to extended-reality glasses, e.g., augmented-reality glasses, including but not limited to, techniques for passing a flexible circuit through a hinge of the extended-reality glasses.

### BACKGROUND

Traditional extended-reality glasses have a limited amount of space to fit the electronics necessary for operation of the glasses. Increasing the number or size of electronic components used in the extended-reality glasses can increase the operational capabilities of the glasses but can also increase the weight or bulkiness of the glasses, which can make the glasses uncomfortable.

As such, there is a need to address one or more of the above-identified challenges. A brief summary of solutions to the issues noted above are described below.

### SUMMARY

Having an extended-reality glasses that is able to integrate electronics from a variety of areas within the glasses can extend the operational capabilities of the glasses without adding excess bulk. Extending the amount of space within the glasses for electronics can reduce the overall profile of the glasses, leading to a more comfortable experience for the user. For example, allowing electronics to interface between a front frame of the glasses and a side temple arm of the glasses can allow electronic components to be stored throughout the entire pair of glasses rather than limited to one particular area. This can be accomplished by passing electronics such as a flexible printed circuit through a hinge that connects the front frame of the glasses to the temple arm of the glasses. Doing so can allow data, power, or other information to be passed from electronics in the frame to electronics in the temple arm, increasing the usable area within the glasses. The flexible printed circuit can be accompanied by other electronics and/or other components such as, for example, a coaxial cable overmolded alongside the flexible printed circuit to be passed through the hinge together.

One example of an extended-reality glasses is described herein. This example extended-reality glasses includes an augmented-reality glasses comprising a frame, a temple arm, a flexible printed circuit that electrically connects a first electronic component located within the frame to a second electronic component located in the temple arm, and a split hinge configured to movably couple the frame to the temple arm, wherein the split hinge includes an upper portion for at least partially controlling a movement of the split hinge, a lower portion for at least partially controlling the movement of the split hinge, and a gap defined between the upper portion and the lower portion that is configured to allow a portion of the flexible printed circuit to pass through the split hinge.

Having summarized the first aspect generally related to an augmented-reality glasses with a split hinge, above, the second aspect of passing information through a split hinge of an augmented-reality glasses is now summarized.

In another example, an augmented-reality glasses comprises a frame, a temple arm, a split hinge configured to rotatably couple the frame to the temple arm, and a portion of a flexible printed circuit that is configured to pass through the split hinge and to bidirectionally transfer information or power from a first electrical component housed within the temple arm to a second electrical component housed within the frame.

One example extended-reality glasses includes a temple arm coupled via a hinge to a lens frame that holds two or more lenses/waveguides and that can facilitate an electrical connection between elements in the temple arm and elements in the frame. For example, FIGS. 1A and 1B described herein illustrate a pair of extended-reality glasses with a hinge 106 that is configured to allow a flexible printed circuit to pass through the hinge. FIGS. 2A and 2B show more detailed views and cross-sections of a flexible printed circuit 206 passing through a hinge with a split design. Such a split hinge design can allow a flexible printed circuit to extend through an opening in the hinge and connect electrical components from one side of the hinge to electrical components on another side of the hinge, and the flexible printed circuit can remain passing through the hinge while the hinge moves from open to closed and back.

The devices and/or systems described herein can be configured to include instructions that cause the performance of methods and operations associated with the presentation and/or interaction with an extended-reality (XR) glasses. These methods and operations can be stored on a non-transitory computer-readable storage medium of a device or a system. It is also noted that the devices and systems described herein can be part of a larger, overarching system that includes multiple devices. A non-exhaustive of list of electronic devices that can, either alone or in combination (e.g., a system), include instructions that cause the performance of methods and operations associated with the presentation and/or interaction with an XR experience include an extended-reality headset (e.g., a mixed-reality (MR) headset or an augmented-reality (AR) glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device) which together can include instructions for performing methods and operations associated with the presentation and/or interaction with an extended-reality system (i.e., the XR headset would be part of a system that includes one or more additional devices). Multiple combinations with different related devices are envisioned, but not recited for brevity.

The features and advantages described in the specification are not necessarily all-inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A and 1B illustrate an extended-reality glasses with a hinge that is configured to allow a flexible printed circuit to pass through, in accordance with some embodiments.

FIGS. 2A and 2B illustrate a hinge assembly with a flexible printed circuit passing through the hinge, in accordance with some embodiments.

FIGS. 3A and 3B illustrate a hinge assembly in two positions, in accordance with some embodiments.

FIG. 4 illustrates an exploded view of a hinge assembly, in accordance with some embodiments.

FIG. 5 illustrates an exploded view of a hinge assembly, in accordance with some embodiments.

FIG. 6 illustrates an exploded view of IPX-related layers used in the extended-reality glasses, in accordance with some embodiments.

FIGS. 7A, 7B, and 7C-1 and 7C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR headsets (e.g., glasses) and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors; (iii) IMUs for detecting, for example, angular rate, force, magnetic field, and/or changes in acceleration; (iv) heart rate sensors for measuring a user's heart rate; (v) peripheral oxygen saturation (SpO₂) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiogramar EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

### Hinge for Augmented Reality Glasses

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

As described herein, artificial-reality glasses, also referred to as extended-reality headsets augmented-reality headsets and/or augmented-reality glasses, provide more immersive experiences when the user is comfortable while using or otherwise wearing the headset. As will be described in relation to the following figures, a hinge that allows a flexible printed circuit to pass through the hinge can enhance the user experience of an artificial-reality glasses by permitting information, data, and/or power to be passed through the hinge, connecting various electronic components.

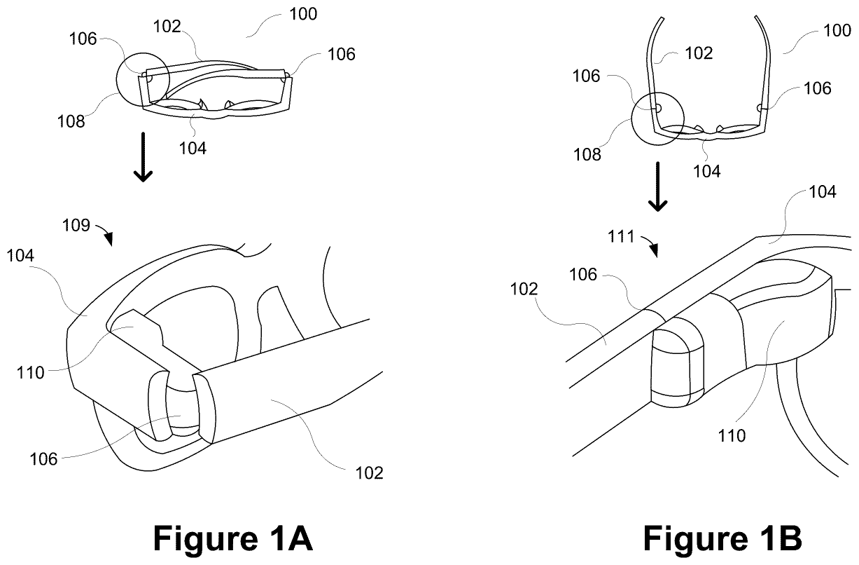

FIGS. 1A and 1B illustrate an extended-reality glasses 100 with a hinge 106 that is configured to allow a flexible printed circuit to pass through, in accordance with some embodiments. This glasses 100 may also be referred to as an augmented-reality glasses, a virtual-reality glasses, or other similar altered-reality terms. FIG. 1A shows an embodiment of an extended-reality glasses 100 in a closed configuration, and FIG. 1B shows an embodiment of glasses 100 in an open configuration. FIGS. 1A and 1B show that glasses 100 has at least one temple arm 102 that extends from a front frame section 104. When in a closed configuration, one or both of temple arms 102 are bent or folded at a hinge 106, such as when glasses 100 is to be stored (e.g., in a charging case). When both temple arms 102 are folded, they may not be folded at the same angle due to how the temple arms 102 interact with each other when folded. The difference in the angle that the temple arms 102 each make with the front frame section 104 at their respective hinge 106 may be, for example, approximately 10 degrees. When in an open configuration, one or both of temple arms 102 are open at hinge 106 or extending straight or substantially straight outward from front frame section 104, such as when glasses 100 is to be worn. In accordance with some embodiments, front frame section 104 holds two or more lenses/waveguides for providing presentation of an augmented reality and/or mixed-reality experience. In some embodiments, glasses 100 can be a pair of smart glasses that do not present an augmented-reality experience.

A region 108 containing hinge 106 is shown in an enlarged view 109. The enlarged view 109 shown in FIG. 1A shows hinge 106 bent in a closed configuration. The enlarged section 111 shown in FIG. 1B shows hinge 106 in an open configuration. An electronics hub 110 connected to temple arm 102 and front frame section 104 allows electronic information to be passed through hinge 106. Electronics hub 110 can contain or connect to hinge 106 that allows temple arms 102 of the extended-reality glasses 100 to open and close. One or both of temple arm 102 and front frame section 104 can contain electronics that interface with electronics in electronics hub 110. Hinge 106 can contain a flexible printed circuit that passes through the hinge, connecting electronics in temple arm 102 to electronics in front frame 104 and/or electronics hub 110.

As shown in FIGS. 1A and 1B, extended-reality glasses 100 shares many features with traditional eyeglasses, including front frame section 104 that holds a plurality of lenses/waveguides and connects to two temple arms 102 that extend back to secure over a wearer's ears. However, one of skill in the art would understand this to be one representative example and that extended-reality glasses 100 can comprise many alternative forms.

The flexible printed circuit passing through the hinge 106 can be configured to bidirectionally transfer information and/or power from an electrical component housed within one or both of temple arms 102 to an electrical component housed within the frame. Other components, such as a coaxial cable, can also be used to transmit high speed shielded signals through the hinge 106. With the flexible printed circuit able to connect electronics from temple arms 102 to front frame section 104 and/or electronics hub 110, electronics are able to be stored and used within many parts of extended-reality glasses 100. In some embodiments, the flexible printed circuit is configured to transmit power from charging contacts that are located within front frame section 104 to a battery that is located within one or both of temple arms 102. The flexible printed circuit can be configured to transmit power from a battery to electrical components located in frame 104. The flexible printed circuit can be configured to transmit power from a battery located within one of temple arms 102 to electrical components within one or both of temple arms 102 or to electrical components within front frame section 104. The flexible printed circuit can extend from one of temple arms 102 to front frame section 104 or can extend continuously from one of temple arms 102 to front frame section 104 and across front frame section 104 and into the second of temple arms 102. In some embodiments, the flexible printed circuit can be segmented and coupled together with a connector. In some embodiments, the flexible printed circuit has a first segment substantially housed within front frame section 104 and a second segment housed within one of temple arms 102. The flexible printed circuit may have a third segment substantially housed within the other of temple arms 102. In some embodiments, there is more than one flexible printed circuit. In some embodiments, extended-reality glasses 100 contains one battery. In some embodiments, extended-reality glasses 100 contains two or more batteries. In some embodiments, a battery is located in front frame section 104 or elsewhere within extended-reality glasses 100.

In some embodiments, electrical components housed within at least one of the temple arms 102 may comprise an inertial measurement unit (IMU). A flexible circuit may be configured to transmit IMU data from the IMU to electronic components housed within frame 104. In some embodiments a first IMU is housed within one of temple arms 102 and a second IMU is housed within the second of temple arms 102. A flexible printed circuit can be configured to transmit IMU data from the second IMU to electrical components housed within front frame section 104. Information transferred by the flexible printed circuit can be configured to cause a change in presentation of an augmented-reality that is displayed at the extended-reality glasses 100. Additionally, data from the first of temple arms 102 and the second of temple arms 102 can be fused together into fused data. This fused data can be used, for example, in extended reality operations of extended-reality glasses 100, including being used to determine a spatial orientation of extended-reality glasses 100. Additionally, extended-reality glasses 100 may comprise a wave guide. The wave guide may be configured to present augmented-reality content.

While these examples are described working with a pair of extended-reality glasses, the principles can be applied to a traditional pair of smart glasses that do not augment a user's perception of reality.

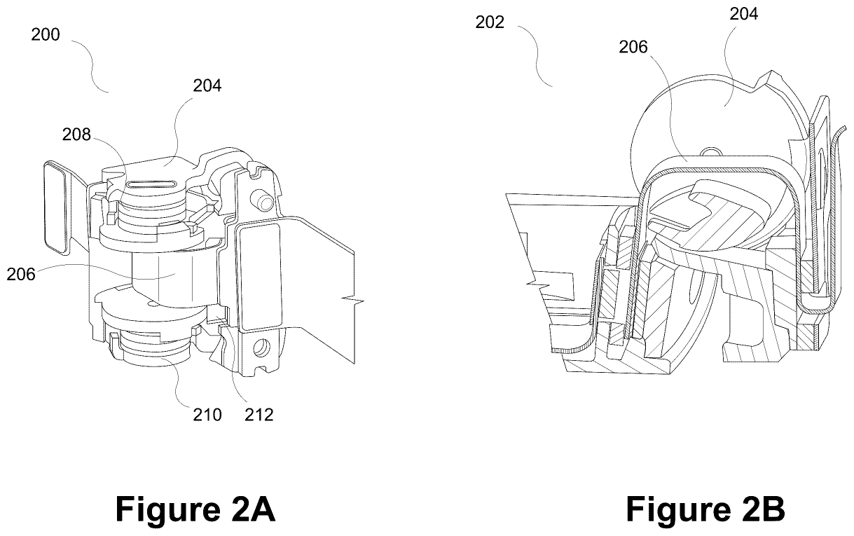

FIGS. 2A and 2B illustrate a hinge assembly 200 with a flexible printed circuit 206 passing through the hinge, in accordance with some embodiments. A hinge assembly 200 is shown in FIG. 2A and is shown in a cross-section view 202 in FIG. 2B. Hinge assembly 200 comprises a hinge frame 204 that is configured to allow a flexible printed circuit 206 to pass through hinge frame 204. Hinge frame 204 has an upper portion that houses an upper spring 208 and has a lower portion that houses a lower spring 210.

In some embodiments, one or both of upper spring 208 and lower spring 210 are configured to control movement of the hinge. When the hinge is in an open or closed position, upper spring 208 and lower spring 210 compress and decompress or twist and untwist to allow the hinge to open and close. Flexible printed circuit 206 is able to pass through one or more openings in hinge frame 204 and is able to bend as it extends through hinge assembly 200 and moves with the opening and closing of the hinge.

Hinge assembly 200 may comprise a split hinge design where an upper portion of the split hinge design contains upper spring 208 and a lower portion of the split hinge design contains lower spring 210, where the upper portion and lower portion are separated by a gap. Flexible printed circuit 206 can be placed within this gap such that flexible printed circuit 206 extends between upper spring 208 and lower spring 210. Further, a portion of hinge frame 204 may comprise an opening or gap 212 that allows flexible printed circuit 206 to pass through hinge assembly 200. Opening or gap 212 may be located on or near a protruding bracket of hinge frame 204, such as shown in FIG. 2A. In some embodiments, opening or gap 212 may be located elsewhere within hinge assembly 200. In some embodiments, hinge assembly 200 may comprise multiple openings or gaps for flexible printed circuit 206 to pass through.

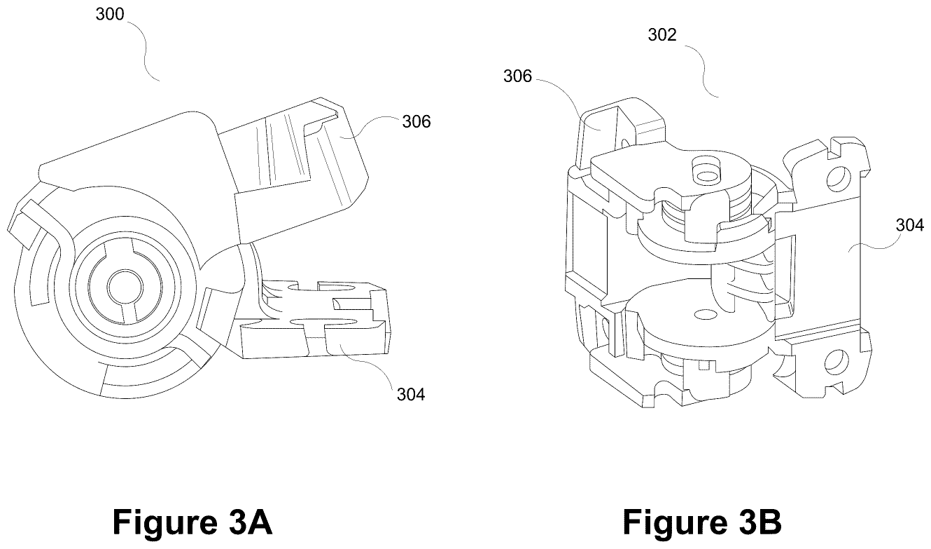

FIGS. 3A and 3B illustrate a hinge assembly in various positions, in accordance with some embodiments. FIG. 3A illustrates an embodiment of a hinge assembly with its springs in a neutral position 300. FIG. 3B illustrates the hinge assembly with its springs in an open position 302. As seen in FIG. 3A and FIG. 3B, the hinge assembly can comprise a first bracket 304 and a second bracket 306. The first bracket 304 may be connected to a main body of the hinge assembly such as where one or more springs are housed. The second bracket 306 may be moveably coupled to the main body of the hinge assembly such that first bracket 304 and second bracket 306 are able to rotate about a shared axis.

As seen in FIG. 3A, when the springs of the hinge assembly are in a neutral position 300, second bracket 306 may extend at an angle of approximately −20 degrees from being parallel with first bracket 304. As seen in FIG. 3B, when the hinge assembly is opened, second bracket 306 may extend at an angle of approximately 80 degrees from the first bracket 304. In some embodiments, the hinge assembly has a −80 to −20 degree range of motion that is not loaded by springs. The range of motion of the hinge assembly between the first bracket 304 and the second bracket 306 being parallel and being open to −20 degrees can be the loaded portion of the hinge, where the springs load the hinge to clamp the device on a user's head. One of skill in the art would additionally understand that such a hinge assembly can be opened or closed to a variety of degrees, including closed more than the neutral position 300 shown in FIG. 3A and opened more than the open position 302 shown in FIG. 3B, as well as the full range of motion between such positions. Additionally, a flexible printed circuit is able to pass through the hinge assembly and bidirectionally transfer information or power from electrical components in the front frame and temple arms while the hinge is open, closed, or in motion between the two. The hinge assembly may be pushed or otherwise closed past the neutral positioning, for example to 0 degrees or such that first bracket 304 and second bracket 306 are parallel. The hinge assembly may be closed such that first bracket 304 and second bracket 306 touch. The hinge assembly may be opened past −80 degrees, for example to −90 degrees, −100 degrees, −110 degrees, −120 degrees, −130 degrees, −140 degrees, −150 degrees, −160 degrees, −170 degrees, −180 degrees, or further.

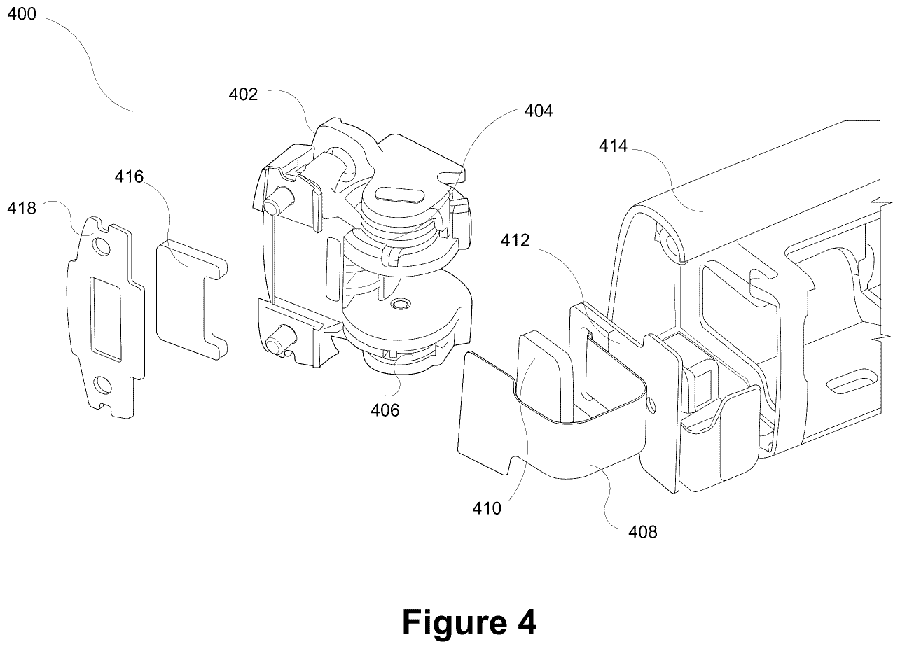

FIG. 4 illustrates an exploded view 400 of a hinge assembly and surrounding components, according to some embodiments. A hinge frame 402 has an upper section that contains an upper spring 404 and a lower section that contains a lower spring 406 (e.g., analogous to upper spring 208 and lower spring 210 shown in FIGS. 2A and 2B). A flexible printed circuit board (flex PCB) 408 can pass through the hinge frame 402 through an area between the upper spring 404 and the lower spring 406. An IPX pad 410 and an IPX sticker 412 can help protect the variety of components within the hinge area including the flex PCB 408 by limiting moisture and debris ingress. A rear frame 414 can connect to the hinge frame 402 on a first side of the hinge frame 402. IPX pad 410 and IPX sticker 412 and at least a portion of flex PCB 408 are capable of being housed within rear frame 414. A foam pad 416 fits within a section of hinge frame 402 on a second side of hinge frame 402, and a foam donut 418 fits over foam pad 416. The foam donut 418 may contain one or more holes that permit screws or other protrusions from hinge frame 402 to fit through the holes, allowing foam donut 418 to fit against foam pad 416 and contact hinge frame 402 when assembled.

The elements shown in exploded view 400 can come together in an assembly that connects a temple arm housing of an extended-reality glasses to a frame of the extended-reality glasses. The IPX and foam elements can provide IPX protection (e.g., moisture and debris protection). As shown, flexible printed circuit 408 can be layered between and bend around IPX pad 410 and IPX sticker 412 such that flexible printed circuit 408 is protected from moisture and other debris. Further, foam pad 416 and foam donut 418 provide similar protections on the side of hinge frame 402 nearer to a temple arm housing.

In some embodiments, flexible printed circuit 408 is routed through pieces of foam such as IPX pad 410 and IPX sticker 412 so that when the assembly is assembled and compressed together using screws, a reliable seal is formed without any adhesive connection to structural components. This allows the assembly to be easily separated to rework the assembly such as to make room for other device components. Structural mounting features of the hinge allow this method of assembly to be accomplished.

IPX layers can be too thick for standard or off-the-shelf connectors to pass through and provide enough compression for an IPX seal around a connector on a flexible printed circuit. Tight alignment requirements are also needed to ensure proper sealing and the ability to align and connect mating components. In some embodiments of the present application, a surface mounted precision machined interposer board that is thick enough to extend the connector through an opening is used, allowing for reliable connection, IPX sealing, and an IPX thickness that is manufacturable.

In some embodiments, an interposer board may be needed to route the signal through the wall thickness of the housing. Manufacturing limitations of the material(s) used in the housing may result in a wall thickness that can interact with a connector thickness to push the connect apart. For example, a magnesium housing may require a minimum wall thickness of approximately 0.6 mm, and a thickness of a connector may be 0.6+/−0.1 mm, which would cause the magnesium to push the connector apart. The wall thickness could be machined down, for example, to 0.4 mm, which would add cost and greater variation in production. Thicker connectors, for example 1.0 mm, could be used, however, the spacing of the signals may be too large for the device and/or would not allow signals to be passed through the FPC. Use of an interposer board can be used instead to route the signals through the wall of the housing. The interposer board may also locate a connector relative to IPX pads.

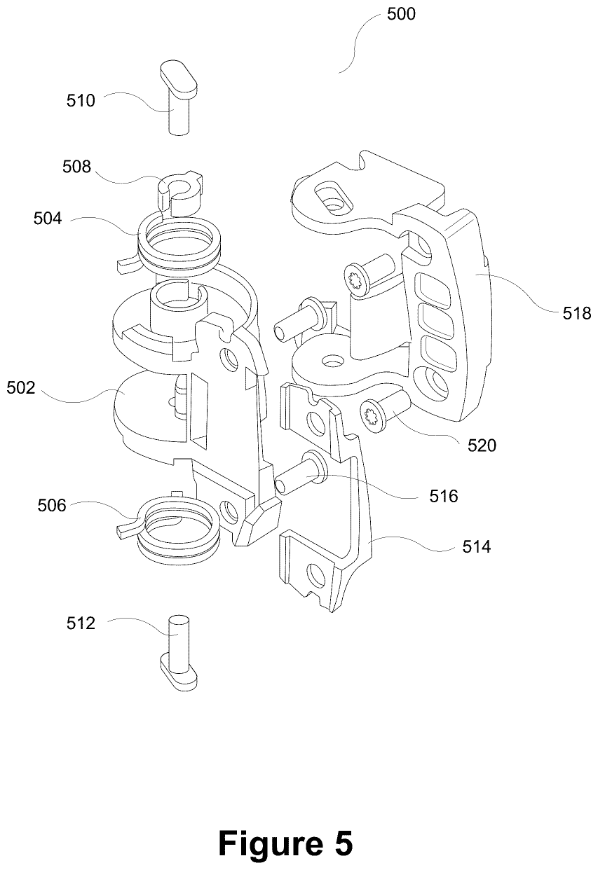

FIG. 5 illustrates an exploded view 500 of an embodiment of a split hinge, in accordance with some embodiments. Exploded view 500 includes a temple arm hinge frame 502 that contains in upper portion that houses an upper spring 504 and a lower portion that houses a lower spring 506. A friction collar 508 connects to the upper portion of temple arm hinge frame 502 and a hinge pin 510 connects to temple arm hinge frame 502 through the friction collar 508. A second hinge pin 512 connects to the lower portion of the temple arm hinge frame 502. A temple arm alignment shim 514 connects to temple arm hinge frame 502 through at least one screw 516. At least one screw 520 connects to a front module hinge frame 518. The front module hinge frame 518 is connected to temple arm hinge frame 502 by hinge pin 510 and hinge pin 512.

As shown in FIG. 5, in some embodiments, the split hinge design comprises front module hinge frame 518 having a bracket area where screws 520 attach, and temple arm hinge frame 502 has a bracket area where screws 516 and temple arm alignment shim 514 attach. These bracket areas can assist in connecting the hinge to the temple arm, frame, or other areas of the extended-reality glasses. An adhesive layer can also be used to aid in attaching temple arm alignment shim 514 or to hold it in place for assembly.

As shown in FIG. 5, in some embodiments, front module hinge frame 518 extends such that front module hinge frame 518 covers both a top and bottom of temple arm hinge frame 502. Hinge pins 510 and 512 slide into designed slots on front module hinge frame 518 to aid in locking front module hinge frame 518 in place over temple arm hinge frame 502. Further, when hinge pins 510 and 512 are in place and front module hinge frame 518 is secured over temple arm hinge frame 502, components within and adjacent to temple arm hinge frame 502, including but not limited to, friction collar 508, upper spring 504, and lower spring 506, are held in place.

In some embodiments, board to board (B2B) connectors are needed to connect two or more printed circuit boards within the augmented-reality device. B2B connectors require retention brackets to ensure the connection remains stable if the device is dropped. In some embodiments, hinge screws such as screws 516 and 520 compress a B2B assembly between foam and titanium brackets, minimizing the use of space. Further, this design can permit the use of strong materials for screw threads.

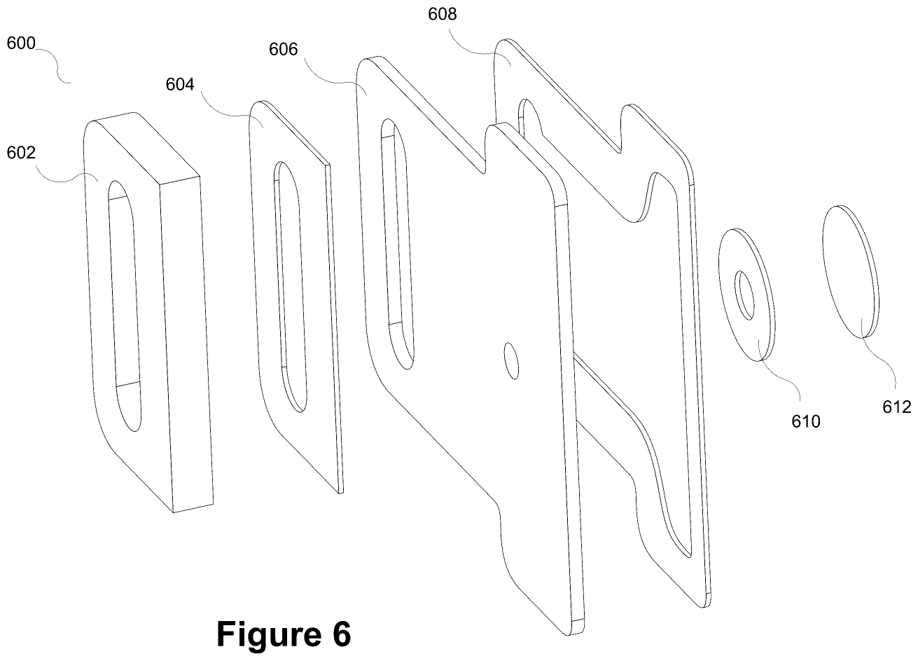

FIG. 6 illustrates an exploded view 600 of IPX-related layers used within the extended-reality glasses, in accordance with some embodiments. In some embodiments, an IPX donut 602 is layered next to an IPX donut adhesive 604, which is connected to an IPX film 606 that is layered next to an IPX donut adhesive 608. A vent mesh assembly containing a first component 610 and a second component 612 can additionally be part of the IPX assembly. IPX donut 602 can be made from a variety of materials, including a foam gasket, very high bond (VHB) adhesive foam sticker, or similar materials. The hinge can compress the flexible printed circuit against the IPX layers, preventing liquid intrusion or the intrusion of other debris. In some embodiments, other IPX designs may be implemented. In some embodiments, no IPX designs may be implemented.

Described below are additional embodiments of the extended-reality glasses described in reference to FIGS. 1A-6.

(A1) In accordance with some embodiments, an augmented reality or extended reality glasses includes a frame and a temple arm (e.g., a temple arm coupled via a hinge to a lens frame that holds two or more lenses/waveguides and can comprise electronic components) as well as a flexible printed circuit that electrically connects a first electronic component located within the frame to a second electronic component located in the temple arm. For example, FIGS. 1A and 1B illustrate temple arms 102 on an extended-reality glasses 100. The augmented-reality glasses also includes a split hinge configured to movably (e.g., via hinge, via rotation, or so that the temple arm can swing relative to the frame) couple the frame to the temple arm. The split hinge includes an upper portion for at least partially controlling a movement of the split hinge, a lower portion for at least partially controlling the movement of the split hinge, and a gap defined between the upper portion and the lower portion that is configured to allow a portion of the flexible printed circuit to pass through the split hinge. For example, FIGS. 2A and 2B show a split hinge with a flexible printed circuit passing between an upper portion and a lower portion of the hinge.

(A2) In some embodiments of A1, the upper portion includes an upper spring and the lower portion includes a lower spring. The springs may share a common axis through a centerpoint of the springs, and elements attached to the springs may rotate or move relative to that axis.

(A3) In some embodiments of A2, the upper spring and the lower spring are torsion springs. The springs may compress and decompress when the hinge is closed and opened.

(A4) In some embodiments of A1-A3, the temple arm is sealed from an exterior environment using a first material that includes a cut out that allows for the pass through of the flexible printed circuit and a second material that sandwiches the flexible printed circuit between itself and the first material to produce a seal. The first material and second material may aid in liquid proofing the glasses, including protecting the glasses and the electronics it may contain from sweat, water, or liquid, or any debris. Various sealing materials are shown in FIG. 4 and FIG. 6.

(A5) In some embodiments of A4, the first material is a very high bond (VHB) adhesive and the second material is a high-density polyurethane foam. The foam may also be a fine pitch open cell urethane foam.

(A6) In some embodiments of A4-A5, the temple arm includes a recess in which the second material conforms to, which is configured to further facilitate sealing of the temple arm from the exterior environment. FIG. 4 shows recesses in the temple arm that can be filled and sealed.

(A7) In some embodiments of A4-A6, the split hinge is configured to apply pressure to the second material to further facilitate sealing of the temple arm from the exterior environment. FIG. 4 and FIG. 6 show sealing materials and how various components within the hinge assembly can fit together and thereby apply pressure on each other.

(A8) In some embodiments of A4-A7, the seal has at least an IP52 rating. The IPX rating may be higher or lower.

(A9) In some embodiments of any of A1-A8, the hinge is configured to operate in both a folded position and an unfolded position. The flexible printed circuit can remain electrically connected in both the folded position and the unfolded position.

(A10) In some embodiments of any of A1-A9, the upper spring and the lower spring are distinct and separate structures. The upper spring and the lower spring are able to compress and decompress or twist and untwist separately from each other.

(A11) In some embodiments of any of A1-A10, a spring constant of the upper spring is equal to a spring constant of the lower spring. In other embodiments, the upper and lower spring may have different spring constants.

(A12) In some embodiments of any of A1-A11, the augmented-reality glasses further comprises a second temple arm and a second split hinge configured to movably couple the frame to the second temple arm. The second split hinge may include a second upper portion for at least partially controlling the movement of the second split hinge, a second lower portion for at least partially controlling the movement of the second split hinge, and a second gap defined between the second upper portion and the second lower portion that is configured to allow a second portion of the flexible printed circuit to pass through the second split hinge.

(A13) In some embodiments of any of A1-A12, the split hinge includes a first bracket and a second bracket. The first bracket and the second bracket may be configured to interface in such a manner as to control the movement of the upper spring and the lower spring. The first bracket may be connected to the upper portion and the lower portion. The second bracket may be movably connected to the first bracket. The first bracket and second bracket may be configured to rotate relative to each other about a common axis. The brackets may extend outwardly from the hinge assembly and may provide areas to mount the brackets onto areas of the augmented-reality glasses, such as the front frame and the temple arms. The first and second brackets are shown, for example, in FIGS. 3A and 3B as the hinge assembly is opened to various degrees.

(A14) In some embodiments of A13, the first bracket includes the gap that accommodates the flexible printed circuit. The gap may be a hole located within the bracket that is big enough for the flexible printed circuit to pass through.

(A15) In some embodiments of A13-A14, the first bracket is affixed to a first portion of the glasses and the second bracket is affixed to a second portion of the glasses.

(A16) In some embodiments of A13-A15, the first spring and the second spring are centered about the common axis and wherein the first spring and the second spring twist when the first bracket and the second bracket rotate relative to each other. FIGS. 3A and 3B illustrate the hinge assembly open in different positions, or with the springs twisted to different degrees.

(A17) In some embodiments of any of A1-A16, a bending radius of the flexible printed circuit is at least 10 times greater than a thickness of the flexible printed circuit. A ratio of bending radius to thickness of the FPC must allow for the FPC to move between different hinge positions. The hinge assembly itself may be large enough to accommodate a flexible printed circuit passing through the hinge, but small enough to comfortably fit on a wearable glasses.

(A18) In some embodiments of any of A1-A17, the augmented-reality glasses further comprises a wave guide configured to present augmented reality content.

(B1) In accordance with some embodiments, a split hinge of an augmented-reality glasses comprises an upper portion comprising an upper spring for at least partially controlling a movement of the split hinge and a lower portion comprising a lower spring for at least partially controlling the movement of the split hinge. The lower portion may be located spaced apart from the upper portion such that a gap is formed between the upper portion and the lower portion. The gap may be configured to permit a portion of a flexible printed circuit to extend through the split hinge such that the flexible printed circuit can electrically connect a first electrical element of a temple arm to a second electrical element of a frame.

(C1) In accordance with some embodiments, a method comprises presenting an extended-reality augment at a display of an augmented-reality glasses. The augmented-reality glasses may comprise a flexible printed circuit that electrically connects a first electrical component located within a frame to a second electrical component located within a temple arm and a split hinge configured to movably couple the frame to the temple arm. The split hinge may include an upper portion for at least partially controlling a movement of the split hinge, a lower portion for at least partially controlling the movement of the split hinge, and a gap defined between the upper portion and the lower portion that is configured to allow the flexible printed circuit to pass through the split hinge.

(D1) In accordance with some embodiments, an augmented-reality glasses comprises a frame, a temple arm, and a split hinge configured to rotatably couple the frame to the temple arm. A portion of a flexible printed circuit is configured to pass through the split hinge and to bidirectionally transfer information or power from a first electrical component housed within the temple arm to a second electrical component housed within the frame. FIGS. 1A and 1B illustrate an example augmented-reality glasses with a frame and two temple arms, and a split hinge coupling each temple arm to the frame.

(D2) In some embodiments of D1, the flexible circuit is configured to transmit power from charging contacts located within the frame to a battery located within the temple arm. One or more batteries may be located within and used by the augmented-reality glasses.

(D3) In some embodiments of D1-D2, the flexible circuit is configured to transmit power from the battery to the second electrical component in the frame.

(D4) In some embodiments of D1-D3, the electrical component in the temple arm comprises an inertial measurement unit (IMU) and the flexible circuit is configured to transmit IMU data from the IMU to the second electrical component housed within the frame.

(D5) In some embodiments of D1-D4, the information transferred by the flexible printed circuit is configured to cause a change in presentation of an augmented-reality displayed at the augmented-reality glasses.

(D6) In some embodiments of D1-D5, the flexible circuit is configured to transmit power from a battery located within the temple arm to the first electrical component and the second electrical component.

(D7) In some embodiments of D1-D6, the split hinge comprises a first spring and a second spring, and the portion of the flexible printed circuit passes through the split hinge between the first spring and the second spring. The flexible printed circuit passing through a gap in the split hinge is shown, for example, in FIGS. 2A and 2B.

(D8) In some embodiments of D1-D7, the split hinge is configured to move between an open position and a closed position, and wherein the portion of the flexible printed circuit is configured to pass through the split hinge and bidirectionally transfer information or power from the first electrical component to the second electrical component in both the open position and the closed position. The split hinge opened in various positions is illustrated, for example, in FIGS. 3A and 3B.

(D9) In some embodiments of D1-D8, the augmented-reality glasses further comprises a second temple arm, and a second split hinge configured to movably, hingeably, or rotatably couple the frame to the second temple arm, wherein a second portion of the flexible printed circuit is configured to pass through the second split hinge and to bidirectionally transfer information or power from a third electrical component housed within the second temple arm to the second electrical component housed within the frame.

(D10) In some embodiments of D9, the flexible circuit is continuous and passes through the temple arm, the frame, and the second temple arm.

(D11) In some embodiments of D9-D10, the third electrical component in the second temple arm is a second inertial measurement unit (IMU) and the flexible circuit is configured to transmit IMU data from the second IMU to the second electrical component housed within the frame.

(D12) In some embodiments of D9-D11, data and/or signals from the temple arm and data from the second temple arm can be fused into fused data.

(D13) In some embodiments of D12, the fused data can be used to determine a spatial orientation of the glasses. The spatial orientation of the glasses may be used for augmented-reality content provided by the augmented-reality glasses.

(D14) In some embodiments of D1-D13, the flexible printed circuit is segmented and coupled together using a connector.

(D15) In some embodiments of D1-D14, the flexible printed circuit has a first segment that is substantially housed within the frame and a second segment that is substantially housed within the temple arm.

(D16) In some embodiments of D1-D15, the flexible printed circuit has a third segment that is substantially housed within the second temple arm.

(D17) In some embodiments of D1-D16, the augmented-reality glasses further comprises a wave guide configured to present augmented reality content.

(E1) In accordance with some embodiments, a split hinge for passing information bidirectionally through a hinge comprises an upper portion for at least partially controlling a movement of the split hinge and a lower portion for at least partially controlling the movement of the split hinge. The lower portion may be located below the upper portion such that a gap is formed between the upper portion and the lower portion. The gap may be configured to permit a flexible printed circuit to extend through the split hinge and electrically connect a first electrical element located on one side of the split hinge to a second electrical element located on a second side of the split hinge to bidirectionally pass information and/or power between the first electrical element and the second electrical element.

(F1) In accordance with some embodiments, a method comprises presenting an extended-reality augment at a display of an augmented-reality glasses. The augmented-reality glasses may comprise a flexible printed circuit that electrically connects a first electrical component located within a frame to a second electrical component located within a temple arm to bidirectionally pass information and/or power between the first electrical component and the second electrical component. A split hinge may be configured to movably couple the frame to the temple arm. The split hinge may include an upper portion for at least partially controlling a movement of the split hinge, a lower portion for at least partially controlling the movement of the split hinge, and a gap defined between the upper portion and the lower portion that is configured to allow the flexible printed circuit to pass through the split hinge and connect from the frame to the temple arm.

### Example Extended-Reality Systems

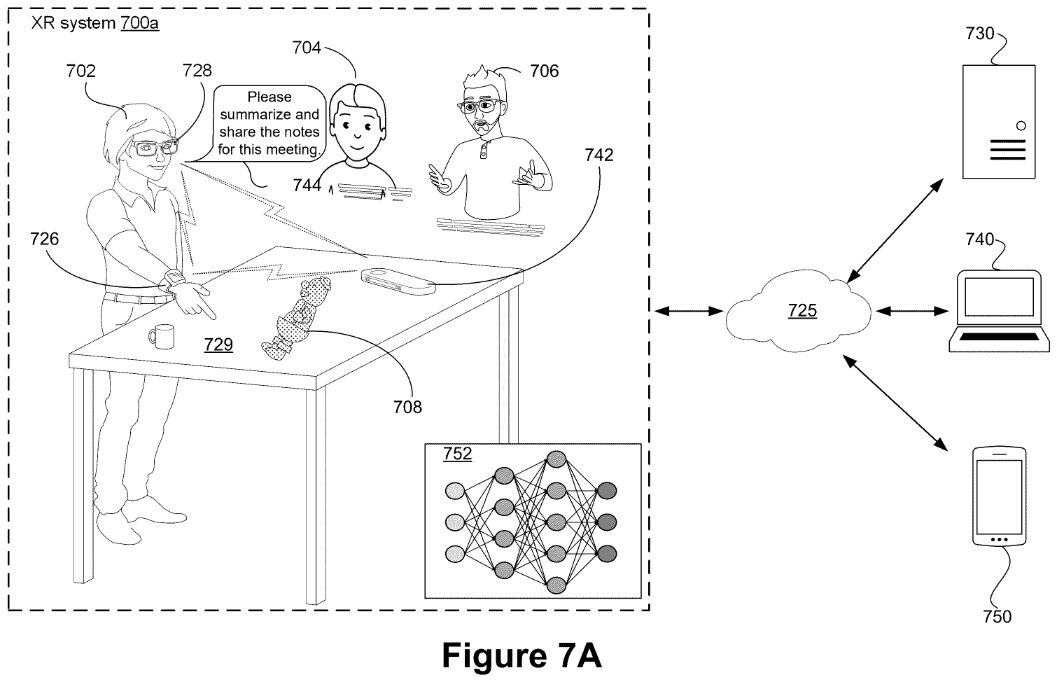

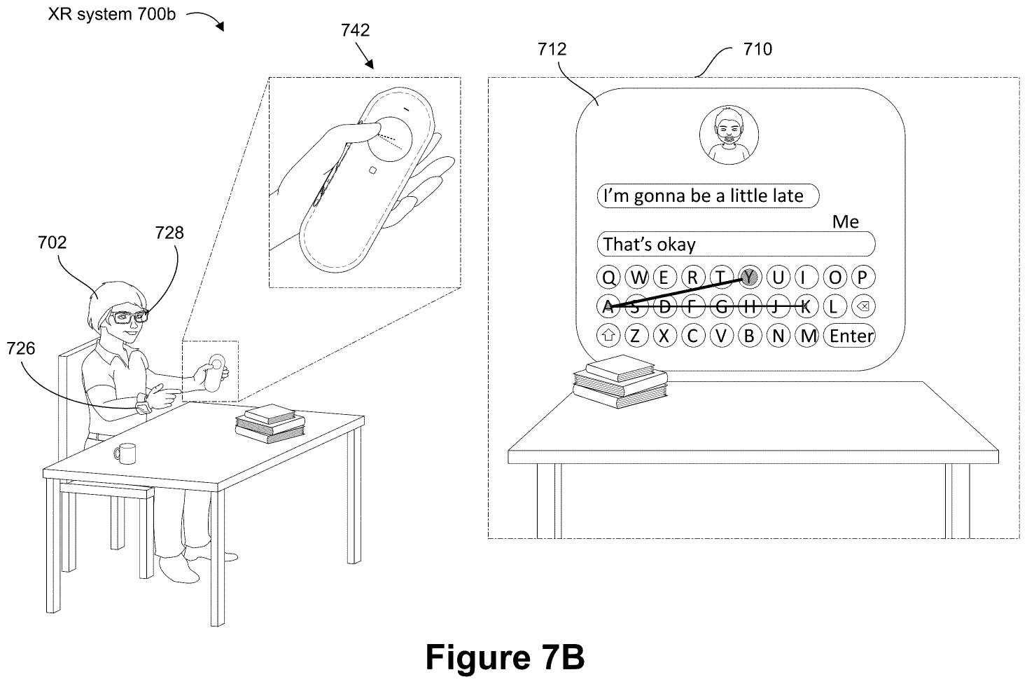

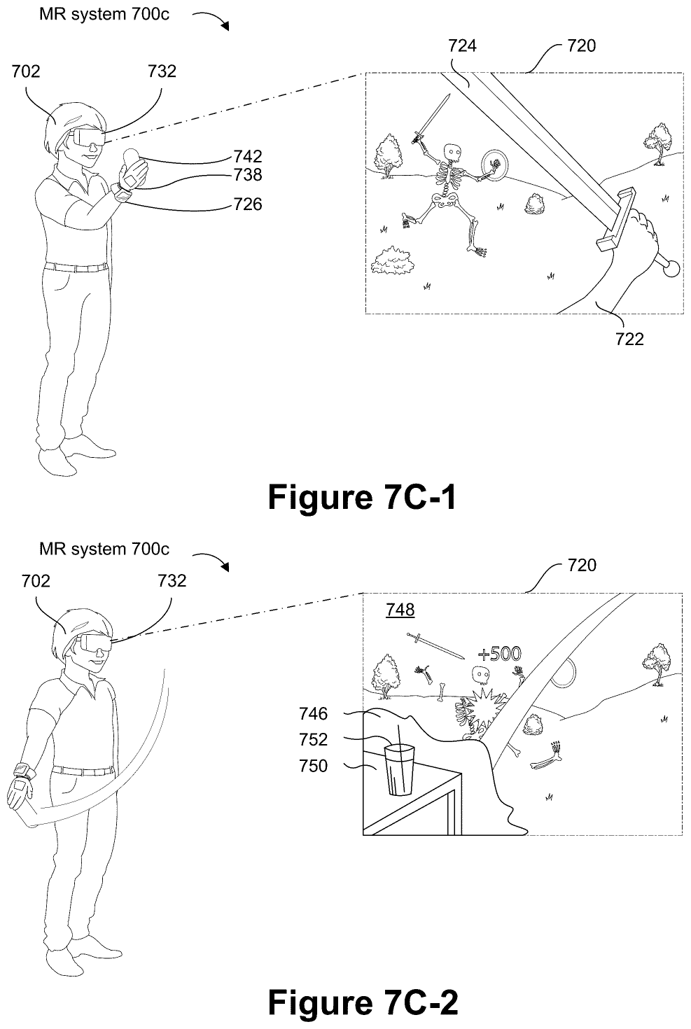

FIG. 7A 7B, 7C-1, and 7C-2, illustrate example XR systems that include AR and MR systems, in accordance with some embodiments. FIG. 7A shows a first XR system 700a and first example user interactions using a wrist-wearable device 726, a head-wearable device (e.g., AR device 728), and/or a HIPD 742. FIG. 7B shows a second XR system 700b and second example user interactions using a wrist-wearable device 726, AR device 728, and/or an HIPD 742. FIGS. 7C-1 and 7C-2 show a third MR system 700c and third example user interactions using a wrist-wearable device 726, a head-wearable device (e.g., an MR device such as a VR device), and/or an HIPD 742. As the skilled artisan will appreciate upon reading the descriptions provided herein, the above-example AR and MR systems (described in detail below) can perform various functions and/or operations.

The wrist-wearable device 726, the head-wearable devices, and/or the HIPD 742 can communicatively couple via a network 725 (e.g., cellular, near field, Wi-Fi, personal area network, wireless LAN). Additionally, the wrist-wearable device 726, the head-wearable device, and/or the HIPD 742 can also communicatively couple with one or more servers 730, computers 740 (e.g., laptops, computers), mobile devices 750 (e.g., smartphones, tablets), and/or other electronic devices via the network 725 (e.g., cellular, near field, Wi-Fi, personal area network, wireless LAN). Similarly, a smart textile-based garment, when used, can also communicatively couple with the wrist-wearable device 726, the head-wearable device(s), the HIPD 742, the one or more servers 730, the computers 740, the mobile devices 750, and/or other electronic devices via the network 725 to provide inputs.

Turning to FIG. 7A, a user 702 is shown wearing the wrist-wearable device 726 and the AR device 728 and having the HIPD 742 on their desk. The wrist-wearable device 726, the AR device 728, and the HIPD 742 facilitate user interaction with an AR environment. In particular, as shown by the first AR system 700a, the wrist-wearable device 726, the AR device 728, and/or the HIPD 742 cause presentation of one or more avatars 704, digital representations of contacts 706, and virtual objects 708. As discussed below, the user 702 can interact with the one or more avatars 704, digital representations of the contacts 706, and virtual objects 708 via the wrist-wearable device 726, the AR device 728, and/or the HIPD 742. In addition, the user 702 is also able to directly view physical objects in the environment, such as a physical table 729, through transparent lens(es) and waveguide(s) of the AR device 728. Alternatively, an MR device could be used in place of the AR device 728 and a similar user experience can take place, but the user would not be directly viewing physical objects in the environment, such as table 729, and would instead be presented with a virtual reconstruction of the table 729 produced from one or more sensors of the MR device (e.g., an outward facing camera capable of recording the surrounding environment).

The user 702 can use any of the wrist-wearable device 726, the AR device 728 (e.g., through physical inputs at the AR device and/or built-in motion tracking of a user's extremities), a smart-textile garment, externally mounted extremity tracking device, the HIPD 742 to provide user inputs, etc. For example, the user 702 can perform one or more hand gestures that are detected by the wrist-wearable device 726 (e.g., using one or more EMG sensors and/or IMUs built into the wrist-wearable device) and/or AR device 728 (e.g., using one or more image sensors or cameras) to provide a user input. Alternatively, or additionally, the user 702 can provide a user input via one or more touch surfaces of the wrist-wearable device 726, the AR device 728, and/or the HIPD 742, and/or voice commands captured by a microphone of the wrist-wearable device 726, the AR device 728, and/or the HIPD 742. The wrist-wearable device 726, the AR device 728, and/or the HIPD 742 include an artificially intelligent digital assistant to help the user in providing a user input (e.g., completing a sequence of operations, suggesting different operations or commands, providing reminders, confirming a command). For example, the digital assistant can be invoked through an input occurring at the AR device 728 (e.g., via an input at a temple arm of the AR device 728). In some embodiments, the user 702 can provide a user input via one or more facial gestures and/or facial expressions. For example, cameras of the wrist-wearable device 726, the AR device 728, and/or the HIPD 742 can track the user 702's eyes for navigating a user interface.

The wrist-wearable device 726, the AR device 728, and/or the HIPD 742 can operate alone or in conjunction to allow the user 702 to interact with the AR environment. In some embodiments, the HIPD 742 is configured to operate as a central hub or control center for the wrist-wearable device 726, the AR device 728, and/or another communicatively coupled device. For example, the user 702 can provide an input to interact with the AR environment at any of the wrist-wearable device 726, the AR device 728, and/or the HIPD 742, and the HIPD 742 can identify one or more back-end and front-end tasks to cause the performance of the requested interaction and distribute instructions to cause the performance of the one or more back-end and front-end tasks at the wrist-wearable device 726, the AR device 728, and/or the HIPD 742. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 742 can perform the back-end tasks and provide the wrist-wearable device 726 and/or the AR device 728 operational data corresponding to the performed back-end tasks such that the wrist-wearable device 726 and/or the AR device 728 can perform the front-end tasks. In this way, the HIPD 742, which has more computational resources and greater thermal headroom than the wrist-wearable device 726 and/or the AR device 728, performs computationally intensive tasks and reduces the computer resource utilization and/or power usage of the wrist-wearable device 726 and/or the AR device 728.

In the example shown by the first AR system 700a, the HIPD 742 identifies one or more back-end tasks and front-end tasks associated with a user request to initiate an AR video call with one or more other users (represented by the avatar 704 and the digital representation of the contact 706) and distributes instructions to cause the performance of the one or more back-end tasks and front-end tasks. In particular, the HIPD 742 performs back-end tasks for processing and/or rendering image data (and other data) associated with the AR video call and provides operational data associated with the performed back-end tasks to the AR device 728 such that the AR device 728 performs front-end tasks for presenting the AR video call (e.g., presenting the avatar 704 and the digital representation of the contact 706).

In some embodiments, the HIPD 742 can operate as a focal or anchor point for causing the presentation of information. This allows the user 702 to be generally aware of where information is presented. For example, as shown in the first AR system 700a, the avatar 704 and the digital representation of the contact 706 are presented above the HIPD 742. In particular, the HIPD 742 and the AR device 728 operate in conjunction to determine a location for presenting the avatar 704 and the digital representation of the contact 706. In some embodiments, information can be presented within a predetermined distance from the HIPD 742 (e.g., within five meters). For example, as shown in the first AR system 700a, virtual object 708 is presented on the desk some distance from the HIPD 742. Similar to the above example, the HIPD 742 and the AR device 728 can operate in conjunction to determine a location for presenting the virtual object 708. Alternatively, in some embodiments, presentation of information is not bound by the HIPD 742. More specifically, the avatar 704, the digital representation of the contact 706, and the virtual object 708 do not have to be presented within a predetermined distance of the HIPD 742. While an AR device 728 is described working with an HIPD, an MR glasses can be interacted with in the same way as the AR device 728.

User inputs provided at the wrist-wearable device 726, the AR device 728, and/or the HIPD 742 are coordinated such that the user can use any device to initiate, continue, and/or complete an operation. For example, the user 702 can provide a user input to the AR device 728 to cause the AR device 728 to present the virtual object 708 and, while the virtual object 708 is presented by the AR device 728, the user 702 can provide one or more hand gestures via the wrist-wearable device 726 to interact and/or manipulate the virtual object 708. While an AR device 728 is described working with a wrist-wearable device 726, an MR glasses can be interacted with in the same way as the AR device 728.

### Integration of Artificial Intelligence With XR Systems

FIG. 7A illustrates an interaction in which an artificially intelligent virtual assistant can assist in requests made by a user 702. The AI virtual assistant can be used to complete open-ended requests made through natural language inputs by a user 702. For example, in FIG. 7A the user 702 makes an audible request 744 to summarize the conversation and then share the summarized conversation with others in the meeting. In addition, the AI virtual assistant is configured to use sensors of the XR system (e.g., cameras of an XR glasses, microphones, and various other sensors of any of the devices in the system) to provide contextual prompts to the user for initiating tasks.

FIG. 7A also illustrates an example neural network 752 used in Artificial Intelligence applications. Uses of Artificial Intelligence (AI) are varied and encompass many different aspects of the devices and systems described herein. AI capabilities cover a diverse range of applications and deepen interactions between the user 702 and user devices (e.g., the AR device 728, an MR device 732, the HIPD 742, the wrist-wearable device 726). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 702 can interact with an AI model through natural language inputs captured by a voice sensor, text inputs, or any other input modality that accepts natural language and/or a corresponding voice sensor module. In another instance, input is provided by tracking the eye gaze of a user 702 via a gaze tracker module. Additionally, the AI model can also receive inputs beyond those supplied by a user 702. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors' data can be retrieved entirely from a single device (e.g., AR device 728) or from multiple devices that are in communication with each other (e.g., a system that includes at least two of an AR device 728, an MR device 732, the HIPD 742, the wrist-wearable device 726, etc.). The AI model can also access additional information (e.g., one or more servers 730, the computers 740, the mobile devices 750, and/or other electronic devices) via a network 725.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 728, an MR device 732, the HIPD 742, the wrist-wearable device 726) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 728, an MR device 732, the HIPD 742, the wrist-wearable device 726), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR glasses, user interfaces displayed at a wrist-wearable device, laptop device, mobile device, etc. On devices with or without displays (e.g., HIPD 742), haptic feedback can provide information to the user 702. An AI model can also use the inputs described above to determine the appropriate modality and device(s) to present content to the user (e.g., a user walking on a busy road can be presented with an audio output instead of a visual output to avoid distracting the user 702).

### Example Augmented Reality Interaction

FIG. 7B shows the user 702 wearing the wrist-wearable device 726 and the AR device 728 and holding the HIPD 742. In the second AR system 700b, the wrist-wearable device 726, the AR device 728, and/or the HIPD 742 are used to receive and/or provide one or more messages to a contact of the user 702. In particular, the wrist-wearable device 726, the AR device 728, and/or the HIPD 742 detect and coordinate one or more user inputs to initiate a messaging application and prepare a response to a received message via the messaging application.

In some embodiments, the user 702 initiates, via a user input, an application on the wrist-wearable device 726, the AR device 728, and/or the HIPD 742 that causes the application to initiate on at least one device. For example, in the second AR system 700b the user 702 performs a hand gesture associated with a command for initiating a messaging application (represented by messaging user interface 712); the wrist-wearable device 726 detects the hand gesture; and, based on a determination that the user 702 is wearing the AR device 728, causes the AR device 728 to present a messaging user interface 712 of the messaging application. The AR device 728 can present the messaging user interface 712 to the user 702 via its display (e.g., as shown by user 702's field of view 710). In some embodiments, the application is initiated and can be run on the device (e.g., the wrist-wearable device 726, the AR device 728, and/or the HIPD 742) that detects the user input to initiate the application, and the device provides another device operational data to cause the presentation of the messaging application. For example, the wrist-wearable device 726 can detect the user input to initiate a messaging application, initiate and run the messaging application, and provide operational data to the AR device 728 and/or the HIPD 742 to cause presentation of the messaging application. Alternatively, the application can be initiated and run at a device other than the device that detected the user input. For example, the wrist-wearable device 726 can detect the hand gesture associated with initiating the messaging application and cause the HIPD 742 to run the messaging application and coordinate the presentation of the messaging application.

Further, the user 702 can provide a user input provided at the wrist-wearable device 726, the AR device 728, and/or the HIPD 742 to continue and/or complete an operation initiated at another device. For example, after initiating the messaging application via the wrist-wearable device 726 and while the AR device 728 presents the messaging user interface 712, the user 702 can provide an input at the HIPD 742 to prepare a response (e.g., shown by the swipe gesture performed on the HIPD 742). The user 702's gestures performed on the HIPD 742 can be provided and/or displayed on another device. For example, the user 702's swipe gestures performed on the HIPD 742 are displayed on a virtual keyboard of the messaging user interface 712 displayed by the AR device 728.

In some embodiments, the wrist-wearable device 726, the AR device 728, the HIPD 742, and/or other communicatively coupled devices can present one or more notifications to the user 702. The notification can be an indication of a new message, an incoming call, an application update, a status update, etc. The user 702 can select the notification via the wrist-wearable device 726, the AR device 728, or the HIPD 742 and cause presentation of an application or operation associated with the notification on at least one device. For example, the user 702 can receive a notification that a message was received at the wrist-wearable device 726, the AR device 728, the HIPD 742, and/or other communicatively coupled device and provide a user input at the wrist-wearable device 726, the AR device 728, and/or the HIPD 742 to review the notification, and the device detecting the user input can cause an application associated with the notification to be initiated and/or presented at the wrist-wearable device 726, the AR device 728, and/or the HIPD 742.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 728 can present to the user 702 game application data and the HIPD 742 can use a controller to provide inputs to the game. Similarly, the user 702 can use the wrist-wearable device 726 to initiate a camera of the AR device 728, and the user can use the wrist-wearable device 726, the AR device 728, and/or the HIPD 742 to manipulate the image capture (e.g., zoom in or out, apply filters) and capture image data.

While an AR device 728 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR glasses, which is described below in the proceeding sections.

### Example Mixed Reality Interaction

Turning to FIGS. 7C-1 and 7C-2, the user 702 is shown wearing the wrist-wearable device 726 and an MR device 732 (e.g., a device capable of providing either an entirely VR experience or an MR experience that displays object(s) from a physical environment at a display of the device) and holding the HIPD 742. In the third AR system 700c, the wrist-wearable device 726, the MR device 732, and/or the HIPD 742 are used to interact within an MR environment, such as a VR game or other MR/VR application. While the MR device 732 presents a representation of a VR game (e.g., first MR game environment 720) to the user 702, the wrist-wearable device 726, the MR device 732, and/or the HIPD 742 detect and coordinate one or more user inputs to allow the user 702 to interact with the VR game.

In some embodiments, the user 702 can provide a user input via the wrist-wearable device 726, the MR device 732, and/or the HIPD 742 that causes an action in a corresponding MR environment. For example, the user 702 in the third MR system 700c (shown in FIG. 7C-1) raises the HIPD 742 to prepare for a swing in the first MR game environment 720. The MR device 732, responsive to the user 702 raising the HIPD 742, causes the MR representation of the user 722 to perform a similar action (e.g., raise a virtual object, such as a virtual sword 724). In some embodiments, each device uses respective sensor data and/or image data to detect the user input and provide an accurate representation of the user 702's motion. For example, image sensors (e.g., SLAM cameras or other cameras) of the HIPD 742 can be used to detect a position of the HIPD 742 relative to the user 702's body such that the virtual object can be positioned appropriately within the first MR game environment 720; sensor data from the wrist-wearable device 726 can be used to detect a velocity at which the user 702 raises the HIPD 742 such that the MR representation of the user 722 and the virtual sword 724 are synchronized with the user 702's movements; and image sensors of the MR device 732 can be used to represent the user 702's body, boundary conditions, or real-world objects within the first MR game environment 720.

In FIG. 7C-2, the user 702 performs a downward swing while holding the HIPD 742. The user 702's downward swing is detected by the wrist-wearable device 726, the MR device 732, and/or the HIPD 742 and a corresponding action is performed in the first MR game environment 720. In some embodiments, the data captured by each device is used to improve the user's experience within the MR environment. For example, sensor data of the wrist-wearable device 726 can be used to determine a speed and/or force at which the downward swing is performed and image sensors of the HIPD 742 and/or the MR device 732 can be used to determine a location of the swing and how it should be represented in the first MR game environment 720, which, in turn, can be used as inputs for the MR environment (e.g., game mechanics, which can use detected speed, force, locations, and/or aspects of the user 702's actions to classify a user's inputs (e.g., user performs a light strike, hard strike, critical strike, glancing strike, miss) or calculate an output (e.g., amount of damage)).

FIG. 7C-2 further illustrates that a portion of the physical environment is reconstructed and displayed at a display of the MR device 732 while the MR game environment 720 is being displayed. In this instance, a reconstruction of the physical environment 746 is displayed in place of a portion of the MR game environment 720 when object(s) in the physical environment are potentially in the path of the user (e.g., a collision with the user and an object in the physical environment are likely). Thus, this example MR game environment 720 includes (i) an immersive VR portion 748 (e.g., an environment that does not have a corollary counterpart in a nearby physical environment) and (ii) a reconstruction of the physical environment 746 (e.g., table 750 and cup 752). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 726, the MR device 732, and/or the HIPD 742 are described as detecting user inputs, in some embodiments, user inputs are detected at a single device (with the single device being responsible for distributing signals to the other devices for performing the user input). For example, the HIPD 742 can operate an application for generating the first MR game environment 720 and provide the MR device 732 with corresponding data for causing the presentation of the first MR game environment 720, as well as detect the user 702's movements (while holding the HIPD 742) to cause the performance of corresponding actions within the first MR game environment 720. Additionally or alternatively, in some embodiments, operational data (e.g., sensor data, image data, application data, device data, and/or other data) of one or more devices is provided to a single device (e.g., the HIPD 742) to process the operational data and cause respective devices to perform an action associated with processed operational data.

In some embodiments, the user 702 can wear a wrist-wearable device 726, wear an MR device 732, wear smart textile-based garments 738 (e.g., wearable haptic gloves), and/or hold an HIPD 742 device. In this embodiment, the wrist-wearable device 726, the MR device 732, and/or the smart textile-based garments 738 are used to interact within an MR environment (e.g., any AR or MR system described above in reference to FIGS. 7A-7B). While the MR device 732 presents a representation of an MR game (e.g., second MR game environment 720) to the user 702, the wrist-wearable device 726, the MR device 732, and/or the smart textile-based garments 738 detect and coordinate one or more user inputs to allow the user 702 to interact with the MR environment.

In some embodiments, the user 702 can provide a user input via the wrist-wearable device 726, an HIPD 742, the MR device 732, and/or the smart textile-based garments 738 that causes an action in a corresponding MR environment. In some embodiments, each device uses respective sensor data and/or image data to detect the user input and provide an accurate representation of the user 702's motion. While four different input devices are shown (e.g., a wrist-wearable device 726, an MR device 732, an HIPD 742, and a smart textile-based garment 738) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 738) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 738 can be used in conjunction with an MR device and/or an HIPD 742.

While some experiences are described as occurring on an AR device and other experiences are described as occurring on an MR device, one skilled in the art would appreciate that experiences can be ported over from an MR device to an AR device, and vice versa.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 7A-7C-2 provided above are intended to augment the description provided in reference to FIGS. 1A-6. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. An augmented-reality glasses comprising:
a frame;
a temple arm;
a flexible printed circuit that electrically connects a first electronic component located within the frame to a second electronic component located in the temple arm; and
a split hinge configured to movably couple the frame to the temple arm, wherein the split hinge includes:
an upper portion including an upper spring, wherein the upper portion is configured to at least partially control a movement of the split hinge;
a lower portion including a lower spring, wherein the lower portion is configured to at least partially control the movement of the split hinge; and
a gap defined between the upper portion and the lower portion that is configured to allow a portion of the flexible printed circuit to pass through the split hinge.

2. The augmented-reality glasses of claim 1, wherein the upper portion includes an upper spring and the lower portion includes a lower spring.

3. The augmented-reality glasses of claim 1, wherein the temple arm is sealed from an exterior environment using: (i) a first material that includes a cut out that allows for the pass through of the flexible printed circuit and (ii) a second material that sandwiches the flexible printed circuit between itself and the first material to produce a seal.

4. The augmented-reality glasses of claim 3, wherein the first material is a very high bond (VHB) adhesive and the second material is a high-density polyurethane foam.

5. The augmented-reality glasses of claim 3, wherein the temple arm includes a recess to which the second material conforms, which is configured to further facilitate sealing of the temple arm from an exterior environment.

6. The augmented-reality glasses of claim 3, wherein the split hinge is configured to apply pressure to the second material to further facilitate sealing of the temple arm from an exterior environment.

7. The augmented-reality glasses of claim 1, wherein the hinge is configured to operate in (i) a folded position and (ii) an unfolded position, wherein the flexible printed circuit remains electrically connected in both the folded position and the unfolded position.

8. The augmented-reality glasses of claim 1, further comprising a second temple arm and a second split hinge configured to movably couple the frame to the second temple arm, wherein the second split hinge includes:
a second upper portion for at least partially controlling the movement of the second split hinge;
a second lower portion for at least partially controlling the movement of the second split hinge; and
a second gap defined between the second upper portion and the second lower portion that is configured to allow a second portion of the flexible printed circuit to pass through the second split hinge.

9. The augmented-reality glasses of claim 1, wherein:
the split hinge includes a first bracket and a second bracket, wherein:
(i) the first bracket and the second bracket are configured to interface in such a manner as to control the movement of the upper spring and the lower spring,
(ii) the first bracket is connected to the upper portion and the lower portion,
(iii) the second bracket is movably connected to the first bracket, and
(iv) the first bracket and second bracket are configured to rotate relative to each other about a common axis.

10. The augmented-reality glasses of claim 9, wherein the first bracket includes the gap that accommodates the flexible printed circuit.

11. The augmented-reality glasses of claim 9, wherein the first bracket is affixed to a first portion of the glasses and the second bracket is affixed to a second portion of the glasses.

12. The augmented-reality glasses of claim 9, wherein the upper spring and the lower spring are centered about the common axis and wherein the upper spring and the lower spring twist when the first bracket and the second bracket rotate relative to each other.

13. An augmented-reality glasses comprising:
a frame;
a temple arm;
a split hinge configured to rotatably couple the frame to the temple arm; and
a portion of a flexible printed circuit that is configured to pass through the split hinge and to bidirectionally transfer information or power from a first electrical component housed within the temple arm to a second electrical component housed within the frame.

14. The augmented-reality glasses of claim 13, wherein the flexible printed circuit is configured to transmit power from charging contacts located within the frame to a battery located within the temple arm.

15. The augmented-reality glasses of claim 14, wherein the flexible printed circuit is configured to transmit power from the battery to the second electrical component in the frame.

16. The augmented-reality glasses of claim 13, wherein the first electrical component in the temple arm comprises an inertial measurement unit (IMU) and the flexible printed circuit is configured to transmit IMU data from the IMU to the second electrical component housed within the frame.

17. The augmented-reality glasses of claim 13, wherein the information transferred by the flexible printed circuit is configured to cause a change in presentation of an augmented-reality displayed at the augmented-reality glasses.

18. The augmented-reality glasses of claim 13, wherein the flexible printed circuit is configured to transmit power from a battery located within the temple arm to the first electrical component and the second electrical component.

19. The augmented-reality glasses of claim 13, wherein the split hinge is configured to move between an open position and a closed position, and wherein the portion of the flexible printed circuit is configured to pass through the split hinge and bidirectionally transfer information or power from the first electrical component to the second electrical component in both the open position and the closed position.

20. A split hinge for passing information bidirectionally through a hinge, the split hinge comprising:
an upper portion for at least partially controlling a movement of the split hinge; and
a lower portion for at least partially controlling the movement of the split hinge, the lower portion being located below the upper portion such that a gap is formed between the upper portion and the lower portion,
wherein the gap is configured to permit a flexible printed circuit to extend through the split hinge and electrically connect a first electrical element located on one side of the split hinge to a second electrical element located on a second side of the split hinge to bidirectionally pass information and/or power between the first electrical element and the second electrical element.
